(19) United States
(12) Patent Application Publication
(10) Pub. No.: US 2012/0050032 A1
(43) Pub. Date: Mar. 1, 2012

(54) TRACKING MULTIPLE CONTACTS ON AN ELECTRONIC DEVICE

(75) Inventor: William Phillip Hough, Portland, OR (US)

(73) Assignee: Sharp Laboratories of America, Inc., Camas, WA (US)

(21) Appl. No.: 12/868,638

(22) Filed: Aug. 25, 2010

(51) Int. Cl. G08B 1/08

(52) U.S. Cl. 340/539.13

(57) ABSTRACT

An electronic device configured for tracking multiple contacts is described. The electronic device includes a processor and instructions stored in memory. The electronic device receives a plurality of current contact locations for a plurality of contacts. The electronic device tracks the plurality of contacts, which includes calculating distance approximations between the plurality of current contact locations and at least one previous contact location and sorting the distance approximations to identify the current contact points. The electronic device also performs an operation based on tracking the plurality of contacts.

### TECHNICAL FIELD

The present disclosure relates generally to electronic devices. More specifically, the present disclosure relates to tracking multiple contacts on an electronic device.

### BACKGROUND

The use of electronic devices has become commonplace in modern society. Electronic devices have become smaller and more powerful in order to meet consumer needs and to improve portability and convenience. Electronic devices that are commonly used include computing devices, such as personal computers or laptops. Other electronic devices commonly used include cellular phones, smart phones, Personal Digital Assistants, tablet devices, netbooks, e-readers, Global Positioning Satellite (GPS) units, etc. Consumers have become dependent upon electronic devices and have come to expect increased functionality.

As electronic devices have advanced, several kinds of interfaces that allow humans to interact with electronic devices have been used. For example, personal computers often use keyboards and mice for interaction. However, other interfaces for interacting with electronic devices have also been presented and adopted by many. For example, touch screens and touch pads are now commonly used. Touch screens and touch pads provide an interface whereby a user can physically touch a touch screen or a touch pad in order to interact with electronic devices. However, current touch or contact tracking may utilize more resources (e.g., processing resources) than is needful. As can be seen from this discussion, improved systems and methods for tracking inputs may be beneficial.

### BRIEF DESCRIPTION OF THE DRAWINGS

FIG. 1 is a block diagram illustrating one configuration of an electronic device on which systems and methods for tracking multiple contacts may be implemented;

FIG. 2 is a block diagram illustrating one example of a configuration of an electronic device in which systems and methods for tracking multiple contacts may be implemented;

FIG. 3 is a flow diagram illustrating one configuration of a method for tracking multiple contacts;

FIG. 4 is a flow diagram illustrating a more specific configuration of a method for tracking multiple contacts;

FIG. 5 is a flow diagram illustrating a specific example of one configuration of a method for tracking multiple contacts;

FIG. 6 is a block diagram illustrating one configuration of a tracking module;

FIG. 7 is a diagram illustrating one example of functional detail of systems and methods for tracking multiple contacts; and

FIG. 8 illustrates various components that may be utilized in an electronic device.

### DETAILED DESCRIPTION

The systems and methods disclosed herein provide a solution for assigning consistent identities to multiple contacts upon a touch screen surface. Currently, this problem is solved by matching a known pattern of a hand to the captured pattern of contact locations. This requires the location of the palm as an anchor point.

Recent improvements in touch screen sensing technology have made possible the detection of a plurality of two or more contacts within a sensing area. As contact location information is updated, it is advantageous to provide locations in a manner in which they can be grouped as tracks of single contacts throughout time. For purposes of identifying a useful event, for example, an application may need to separate the track of a single finger across a touch surface from the tracks of a multitude of other fingers.

The systems and methods disclosed herein address the problem of identifying the movement of a contact throughout time using a sensor that concurrently detects the movement of multiple contacts. Two groups of touch locations may be examined. The first group of locations is those reported by the sensor for the most recent contacts. The second group of locations is those reported by the sensor from a time prior to the current time. The collection of points from the past may be assumed to have been assigned relevant identifiers for each location.

The systems and methods disclosed herein may use an algorithm that searches for the most likely transitions between past and present locations. This may be accomplished by calculating all possible distances that each past location may have taken to arrive at a location within the current data set. This may result in distances for each possible pairing of one location from the past group with one location from the most recent group. These distances may be sorted (e.g., in ascending or descending order). The sorting may provide the most likely arrangement of pairings of contacts from the past to the present. The sorting results may provide an identifier for the most recent contact points.

An electronic device configured for tracking multiple contacts is disclosed. The electronic device includes a processor and instructions stored in memory. The electronic device receives a plurality of current contact locations for a plurality of contacts. The electronic device tracks the plurality of contacts, including calculating distance approximations between the plurality of current contact locations and at least one previous contact location and sorting the distance approximations to identify the current contact points. The electronic device also performs an operation based on tracking the plurality of contacts.

Tracking the plurality of contacts may include tracking indices corresponding to the distance approximations. Tracking the plurality of contacts may include determining a mapping. Tracking the plurality of contacts may include reordering the current contact locations in a temporary vector. Tracking the plurality of contacts may include copying the reordered contact locations to a current vector from the temporary vector. Tracking the plurality of contacts may include assigning an index to a new contact.

The distance approximations may be calculated according to an equation di,j=|C[j]−L[i]|, where di,j is a distance approximation, i is an index for a contact location in a previous vector L and j is an index for a contact location in a current vector C. The distance approximations may be calculated according to an equation di,j=|x[j]−last_x[i]|+|y[j]−last_y[i]|, where di,j is a distance approximation, i is an index for a contact location in a previous vector, j is an index for a contact location in a current vector, x is an x coordinate in the current vector, y is a y coordinate in the current vector, last_x is an x coordinate in a previous vector and last_y is a y coordinate in a previous vector.

The distance approximations may be arranged in a distance matrix, where di,j is a distance approximation at indices i and j. The distance approximations may be sorted in ascending order.

Performing an operation may include producing an output using a device included in the electronic device. Performing an operation may include producing an output using a display. The plurality of current contact locations may be received from a touch screen.

A method for tracking multiple contacts is also disclosed. The method includes receiving a plurality of current contact locations for a plurality of contacts. The method also includes tracking the plurality of contacts on an electronic device, including calculating distance approximations between the plurality of current contact locations and at least one previous contact location and sorting the distance approximations to identify the current contact points. The method also includes performing an operation based on tracking the plurality of contacts.

A non-transitory tangible computer-readable medium for tracking multiple contacts is also disclosed. The non-transitory tangible computer-readable medium includes instructions for receiving a plurality of current contact locations for a plurality of contacts. The non-transitory tangible computer-readable medium includes instructions for tracking the plurality of contacts on an electronic device, including calculating distance approximations between the plurality of current contact locations and at least one previous contact location and sorting the distance approximations to identify the current contact points. The non-transitory tangible computer-readable medium also includes instructions for performing an operation based on tracking the plurality of contacts.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods. As used herein, the term “plurality” may indicate two or more. For example, a plurality of components refers to two or more components.

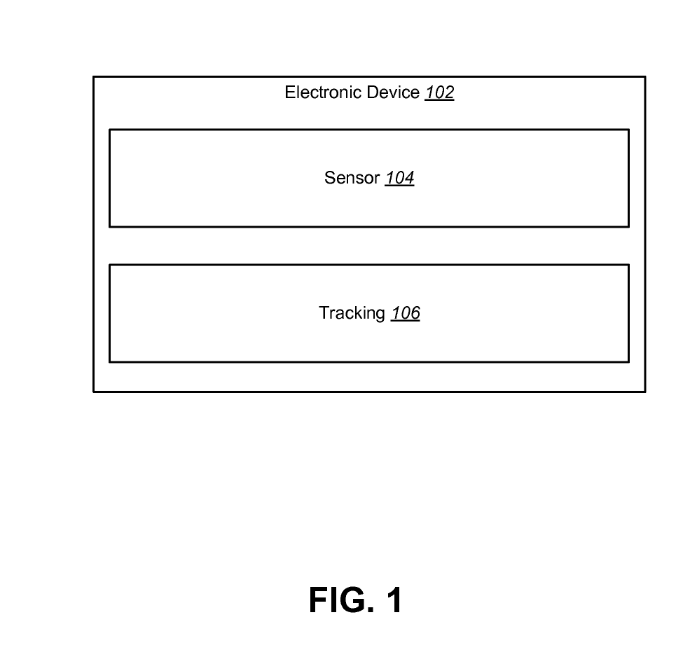

FIG. 1 is a block diagram illustrating one configuration of an electronic device 102 on which systems and methods for tracking multiple contacts may be implemented. Examples of an electronic device 102 include desktop computers, laptop computers, netbooks, e-readers, tablet devices, cellular phones, smart phones, Personal Digital Assistants (PDAs), etc.

The electronic device 102 may include a sensor 104 and a tracking module 106. The sensor 104 may be a sensor that is used to respond to contact. For example, the sensor 104 may use capacitive, resistive, Surface Acoustic Wave (SAW), strain gauge or other technology to detect contact. For instance, a user may interact with the electronic device 102 by touching the sensor 104 with a finger or stylus. The sensor 104 may also detect multiple contacts at once. For example, a user may input a command or trigger an event by touching the sensor 104 and/or making gestures on the sensor 104 with two or more fingers. Examples of the sensor 104 include touch screens and touch pads.

In one configuration, the sensor 104 detects and provides one or more locations of one or more detected contacts to the tracking module 106. The sensor 104 may provide these locations to the tracking module in particular time instances or “frames.” For example, the sensor 104 may provide the locations of multiple contacts at a first time or in a first frame and later provide the locations of fewer, more or an equal number of contacts to the tracking module 106.

The tracking module 106 may be a hardware and/or software module used to track one or more contacts on the sensor 104. For example, the tracking module 106 may track the movement of one or more contacts over time. The movement of one or more contacts may be used to trigger an event or command on the electronic device 102. For example, a user may trigger a zoom out command or event by “pinching” multiple contacts on the sensor 104. Other examples of “multi-touch” commands include a zoom-in command by spreading two or more contacts, a scroll command by swiping two or more contacts in a particular direction, etc. In other words, a vast variety of events or commands may be triggered by using the movement (or non-movement) of one or more contacts on the sensor 104.

The tracking module 106 may thus be used to track movement, distinguish and/or identify one or more contacts. For example, in order to trigger the zoom out event described above, the tracking module 106 may distinguish multiple contacts as they move over time. In one configuration, each contact may be identified in a first (or previous) time frame. In a subsequent (or current) time frame, the tracking module 106 may use locations of contacts given by the sensor 104 to determine which contacts in the current frame correspond to contacts in the previous time frame. In this way, the motions or tracks of each contact may be distinguished from each other. Events or commands may be triggered based on the detected motion or track of individual or multiple contacts.

The tracking module 106 may use an efficient procedure to track multiple contacts. In one configuration, this efficient procedure may calculate distance approximations between current and previous contacts and may sort these distance approximations to likely identify corresponding contacts between previous and current frames.

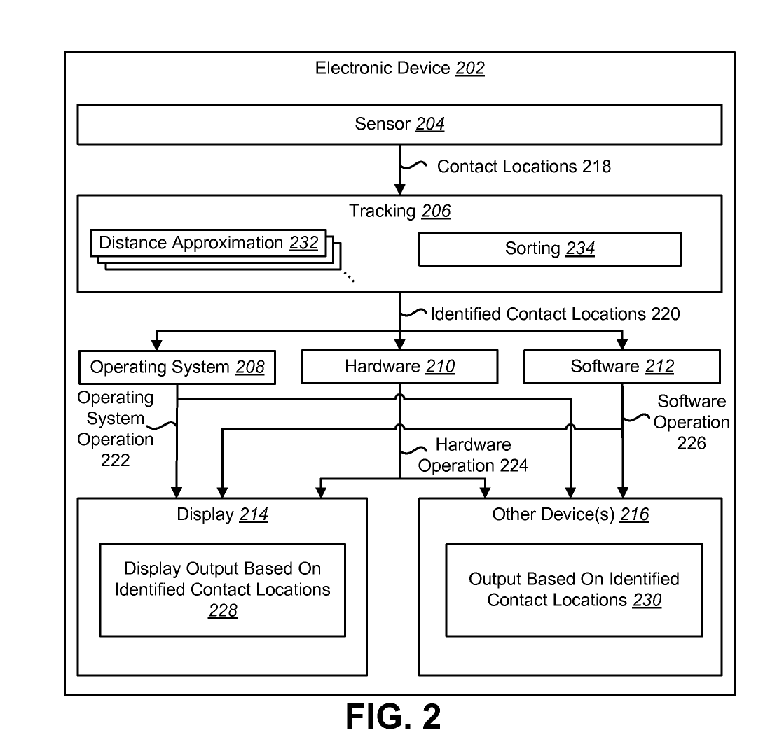

FIG. 2 is a block diagram illustrating one example of a configuration of an electronic device 202 in which systems and methods for tracking multiple contacts may be implemented. The electronic device 202 may include a sensor 204, a tracking module 206, an Operating System (OS) 208, software 212, hardware 210, a display 214 and/or other device(s) 216. The operating system 208 may comprise software, instructions and/or code that provide the electronic device 202 with an operating environment. Examples of the operating system 208 include Microsoft Windows, OS X, Linux, Unix, Google Chrome OS, Android, Symbian OS, iOS, BlackBerry, Palm WebOS, Windows Phone, Maemo, etc. Software 212 may include one or more applications, programs and/or instructions (e.g., code) that run on the electronic device 202. The hardware 210 may comprise electronic circuitry and/or other components that allow the electronic device 202 to operate. Examples of hardware 210 may include one or more displays 214 and/or other device(s) 216, such as integrated circuits, speakers, one or more processors, memory, storage, one or more communication ports, one or more antennas, one or more transmitters, and/or one or more receivers, one or more communication interfaces, etc. The display 214 may display images (e.g., icons, user interfaces (UIs), buttons, media, etc.). The other device(s) 216 may perform other functions, such as outputting sound, communicating with other devices, storing information or data, etc.

The sensor 204 may detect one or more contacts. As used herein, the term “contact” may denote contact between the sensor 204 and some other object. For example, the sensor 204 may detect a contact (e.g., the location of one or more contacts) with one or more fingers, styli, or other objects. In one configuration, the sensor 204 may determine contact locations 218 (e.g., coordinates) for each of the one or more contacts. For example, the sensor 204 may provide contact locations 218 (e.g., x and y coordinates of one or more contacts) to the electronic device 202. For instance, the sensor 204 may provide x and y coordinates of one or more contacts to the tracking module 206 in a series of time frames or instances. More specifically, in each time frame, contact locations 218 (e.g., x and y coordinates) corresponding to one or more contacts may be provided to the tracking module 206 by the sensor 204.

The sensor 204 may comprise, for example, a touch screen or touch pad. In one configuration, the sensor 204 may be combined or integrated with the display 214 to form a touch screen. For instance, the display 214 may display interactive images (e.g., icons, windows, controls such as buttons, sliders, dials, pictures, etc.) that a user may interact with by touching the touch screen that includes the display 214 and sensor 204. In another configuration, the sensor 204 is not integrated with the display 214. For example, the sensor 204 may be a touch pad that is independent of the display 214. However, a user may touch the sensor 204 (e.g., touch pad) in order to control a cursor that is displayed on the display 214. A user may thus use the sensor 204 to interact with the electronic device 202.

The tracking module 206 may track one or more contacts. For example, the tracking module 206 may identify or determine the identity of one or more contacts. More specifically, the tracking module 206 may determine a correspondence between one or more contacts in a current time frame and one or more contacts in a previous time frame. Thus, the one or more contacts in the current time frame may be identified as corresponding to the one or more contacts in the previous time frame. This may allow the electronic device 202 to determine the movement (if any) of the one or more contacts.

In one configuration, the tracking module 206 uses the contact locations 218 provided by the sensor to produce identified contact locations 220. For example, contacts or contact locations 218 from a previous frame may have been identified (e.g., “contact #1,” “contact #2,” “contact #3,” etc.). The tracking module 206 may identify contacts or contact locations 218 in a current frame such that they correspond to the identified contacts or contact locations 218 in the previous frame. The tracking module 206 may calculate one or more distance approximations 232. For example, each distance approximation 232 may be an approximation of a distance between one possible pairing of a contact or contact location in a previous frame and a contact or contact location 218 in a current frame. In one configuration, the tracking module 206 calculates distance approximations 232 for all possible pairings of previous and current contacts or contact locations 218.

The tracking module 206 may sort the distance approximations 232 using a sorting module 234. For example, the sorting module 234 may sort the distance approximations in ascending, descending or some other order. Sorting 234 the distance approximations 232 may provide identified contact locations 220. For example, the smallest distance approximations 232 may indicate the most likely transitions from previous contact locations to current contact locations 218. Using this information, the tracking module 206 may produce identified contact locations 220.

The operating system 208, software 212 and/or hardware 210 on the electronic device 202 may use the identified contact locations 220. For example, the tracking module 206 may provide one or more contact identities, locations of the one or more contacts and/or the movement or motion (if any) of the one or more contacts. In one configuration, for example, the tracking module 206 may trigger an event and/or perform an operation based on the movement (if any) of the one or more contacts. In another configuration, for example, the tracking module 206 provides the identities (and locations, for example) of the one or more contacts to the operating system 208, software 212 and/or hardware 210. For example, the operating system 208, software 212 and/or hardware 210 may use the identified contact locations 220 of the one or more contacts to determine whether a particular movement or pattern of movement has occurred.

For example, the operating system 208, software 212, and/or hardware 210 may use the identified contact locations 220 of one or more contacts identified by the tracking module 206 to trigger an event or operation. More specifically, the operating system 208 may perform an operating system operation 222 based on the identified contact locations 220, the hardware 210 may perform a hardware operation 224 based on the identified contact locations 220 and/or the software 212 may perform a software operation 226 based on the identified contact locations 220. The operating system operation 222, the hardware operation 224 and/or the software operation 226 may be used to generate a display output 228 and/or other device output 230. For example, the operating system operation 222, the hardware operation 224 and/or the software operation 226 may be used to produce a display output 228 based on the identified contact locations using the display 214 and/or an output 230 based on identified contact locations using other device(s) 216.

For instance, the operating system 208, software 212 and/or hardware 210 may use identified contact locations 220 of two contacts to determine if the contacts are moving closer to each other for a pinch event, if the contacts are moving away from each other for a spread event, if the contacts are moving in the same direction for a swipe event or if the contacts are moving in a circular fashion for a rotate event. Assume, for example, that a software 212 application is displaying a photograph on the display 214. The software 212 may use the identified contact locations 220 of multiple contacts to zoom out if a pinch event is triggered, to zoom in if a spread event is triggered, to translate the photograph if a swipe event is triggered or to rotate the photograph if a rotate event is triggered. Generally speaking, the software 212, operating system 208 and/or hardware may use identified contact locations 220 to produce a display output 228 based on identified contact locations.

Other examples of operating system operations 222 that may produce a display output 228 based on identified contact locations include using the identified contact locations 220 to start or close a software 212 application, browse files, open/close files, change operating system settings (e.g., change wallpapers, icon arrangements, function shortcuts, etc.), shut down the electronic device 202, unlock/lock the electronic device 202 and/or other operations. Each of these operating system operations 222 may be displayed as a display output 228 based on identified contact locations on the display 214.

Other examples of hardware operations 224 that may produce a display output 228 based on identified contact locations include adjusting the brightness of the display 214, adjusting the contrast of the display 214, adjusting the display 214 colors, changing the display 214 resolution, changing the display 214 orientation and/or other operations. Each of these hardware operations 224 may produce a display output 228 based on identified contact locations. For instance, a user may rotate two fingers on the sensor 204 to interact with a dial displayed on the display 214. The tracking module 206 provides identified contact locations to hardware 210, which in turn interprets the rotating contacts as a command to output more brightness on the display 214 screen.

A wide variety of software operations 226 may be performed that produce a display output 228 based on identified contact locations 228. Some examples of software operations 226 include zooming in to an image, zooming out of an image, rotating an image, flipping an image, controlling music player operations, making a phone call, controlling a game, browsing the Internet, drawing, sending a text message, composing text, triggering a command, accessing a file, storing a file, composing an email, sending an email, triggering a photo capture, selecting a portion of an image or text and/or myriad other software operations 226. Each of these software operations 226 may produce a display output 228 based on identified contact locations on the display 214.

An operating system operation 222, a hardware operation 224 and/or a software operation 226 may additionally or alternatively produce an output 230 based on identified contact locations on one or more other devices 216. More specifically, the operating system 208 may perform an operating system operation 222, the hardware 210 may perform a hardware operation 224 and/or the software 212 may perform a software operation on one or more other device(s) 216 that produces an output 230 based on identified contact locations. Examples of these operations 222, 224, 226 include increasing/decreasing a volume output (on speakers, for example), muting/unmuting audio, muting/unmuting a microphone, activating/deactivating a wireless networking device (e.g., an Institute of Electronics and Electrical Engineers IEEE 802.11 or “Wi-Fi” chip), changing processor behavior (e.g., increasing/decreasing processor speed), storing data in memory, erasing memory, changing transmitter/receiver behavior (e.g., changing output power, activating/deactivating radio chips, changing broadcast information, changing wireless security settings, etc.), changing settings for input/output ports, powering down the electronic device 202 and/or myriad other operations. Each of these operations may produce an output 230 based on identified contact locations 230.

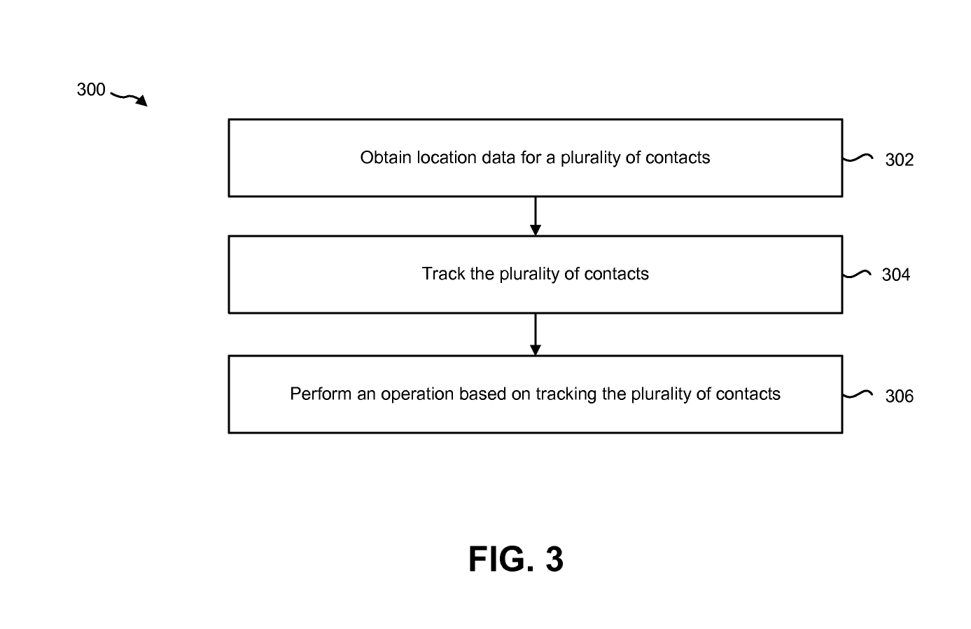

FIG. 3 is a flow diagram illustrating one configuration of a method 300 for tracking multiple contacts. An electronic device 102 may obtain 302 location data for a plurality of (e.g., two or more) contacts. For example, the electronic device 102 may use a sensor 104 to obtain 302 location data for the plurality of contacts. The location data may be expressed as coordinates, such as x and y coordinates.

The electronic device 102 may track 304 the plurality of contacts. For example, the electronic device 102 may calculate a distance approximation between each contact location in a previous time frame and each contact location in a current time frame. For example, these distance approximations may represent each possible pairing of one location from a past group with one location from the most recent group. These distance approximations may be sorted (e.g., in ascending order). The sorting may provide the most likely arrangement of pairings of contacts from the past to the present. The sorting results may provide an identifier for the most recent contacts.

The electronic device 102 may perform 306 an operation based on tracking the plurality of contacts. As discussed above, the electronic device 102 may use the contact tracking to trigger an event or perform an operation. For example, the electronic device 102 may use the tracking 304 to determine whether an event or operation may be performed and/or to select an event or operation for performance. Furthermore, the tracking 304 may be used differently in different contexts. For example, a swipe motion using two fingers may be interpreted as translating a photograph in an image-viewing application, whereas the same motion may be interpreted as moving a window or changing the view to additional “desktop” space while in a desktop context. It should be noted that performing 306 an operation may produce an output on or from the electronic device 102. Some examples of operations that produce an output on or from the electronic device 102 are described above in connection with FIG. 2.

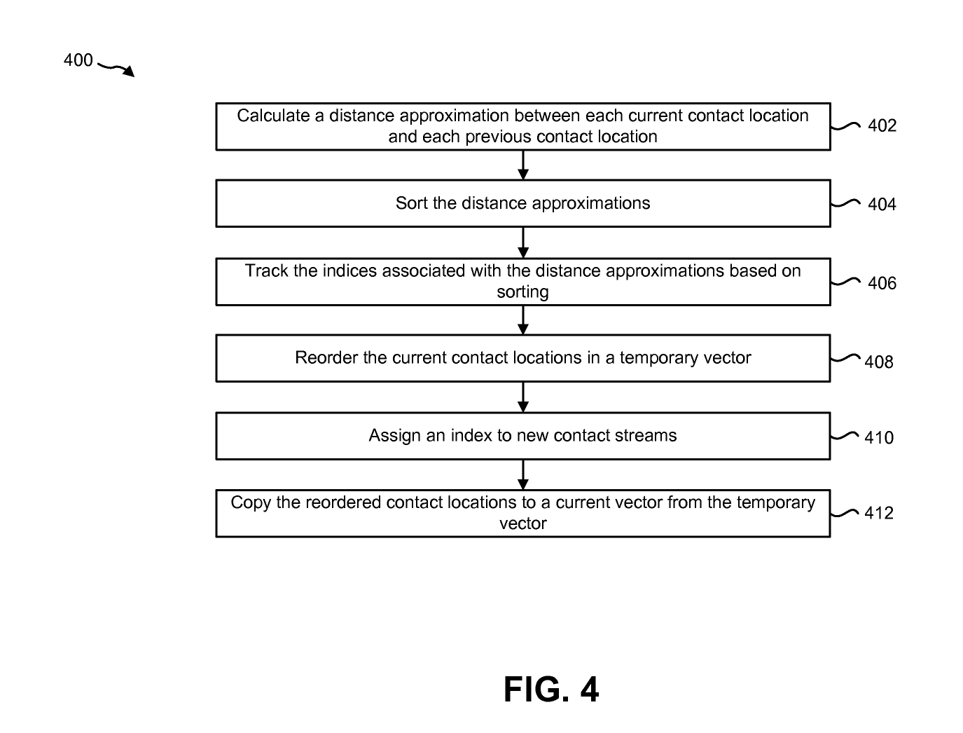

FIG. 4 is a flow diagram illustrating a more specific configuration of a method 400 for tracking multiple contacts. The method 400 may identify multiple contacts using two sensor 104 images taken successively in time. More specifically, given a sensor 104 image from a prior capture with associated identities and a current sensor 104 image with an equal, fewer or greater number of contacts that are not identified, the disclosed method 400 may track the movement of contacts from the prior image to the current image.

An electronic device 102 may calculate 402 a distance approximation between each current contact location and each previous contact location. For example, the electronic device 102 may receive one or more contact locations in a current sensor 104 image (after receiving one or more contact locations in a previous sensor 104 image, for example). The contact locations may be expressed as x and y coordinates. Each distance approximation may be calculated by adding the absolute value of the difference of the current x coordinate and previous x coordinate to the absolute value of the difference of the current y coordinate and previous y coordinate for a given current contact location and a given previous contact location. A distance approximation may be calculated for every possible pairing of previous contact locations and current contact locations. Each of the distance approximations may be placed (e.g., stored) in a matrix at a set of indices. For example, the rows of the matrix may represent a contact index from a previous frame and the columns of the matrix may represent a current contact index. An element representing a distance approximation between the previous and current contact may be placed or stored at the intersection of the indices. For example, row #2 may represent distances between contact #2 from a previous frame and all contacts in the current frame while column #1 may represent distances between a contact #1 in a current frame and all contacts in the previous frame. Thus, the distance approximation between previous contact #2 and current contact #1 may be placed at the indices (2, 1) of the matrix.

The electronic device 102 may sort 404 the distance approximations. In one configuration, the electronic device 102 may sort the distance approximations in ascending order (e.g., from the smallest distance approximation to the largest distance approximation). Other sorting orders (e.g., descending order, etc.) may be used in other configurations, for example. The distance approximations may be sorted using a vector. For example, the electronic device 102 may insert each distance approximation into a vector, shifting distance approximations that are greater than the distance approximation to be inserted in order to sort the distance approximations in ascending order. It should be noted that equal values may not be shifted. For example, in sorting, the test may be to find a value that is greater than, not a value that is greater than or equal to. This approach may reduce the number of elements that need to be shifted, for example.

The electronic device 102 may track 406 the indices associated with the distance approximations based on the distance approximation sorting 404. For example, the electronic device 102 may place the (corresponding matrix) indices for the distance approximations in a vector in an order corresponding to the sorting order (e.g., ascending order) used to sort the distance approximations. For instance, assume that the distance approximations have been placed in a matrix, with the shortest distances in ascending order being at indices (2, 0), (1, 1) and (0, 2) in the matrix (assuming three contact points, for example). When sorted, the distance approximations at those indices are placed in a vector in ascending order. The electronic device 102 may track 406 the indices associated with the distance approximations based on the sorting by placing or storing the indices (2, 0), (1, 1) and (0, 2) in the positions 0, 1 and 2 (i.e., the first three positions) in an index vector. Thus, the indices stored in the index vector may correspond to associated distance approximations in a sorting vector.

The electronic device 102 may determine a mapping and/or map the contact locations. For example, the electronic device 102 may use the index vector to determine which contact is mapped to which position of the current contact locations. For instance, the current contact locations may be stored in a current vector. Continuing with the earlier example, the indices (2, 0), (1, 1) and (0, 2) in the index vector may indicate that a contact 2 is located at the 0 index of the current vector, a contact 1 is located at the 1 index of the current vector and a contact 0 is located at the 2 index of the current vector. In one configuration, this mapping may only be determined for the number of contacts used. For example, the sorting vector and the index vector may include more values (e.g., distance approximations and corresponding indices, respectively) than the number of contacts being used. Thus, the mapping may be determined only for the number of indices corresponding to the number of contacts being used. More detail regarding determining a mapping and/or mapping the contact locations follows.

The electronic device 102 may reorder 408 the current contact locations in a temporary vector. For example, the electronic device 102 may copy contact locations from the current vector into a temporary vector in an order based on the indices in the index vector. For instance, the electronic device 102 may copy the contact location corresponding to a contact 0 (which may be at any index in the current vector, for example) from the current vector into the temporary vector at the index 0 in the temporary vector. The contact location in the current vector may be overwritten with a value that indicates an empty position (e.g., −1). The electronic device 102 may then copy the contact location corresponding to a contact 1 from the current vector into the temporary vector at the index 1 in the temporary vector. Such operation may continue until the contact locations are moved into the temporary vector for all of the valid elements in the index vector.

The electronic device 102 may assign 410 an index to new contact streams. For example, new contact streams (e.g., contacts that have been added since the previous frame) may have elements remaining in the current vector. The electronic device 102 may scan the current vector for value data (of a new contact location, for example). If value data is found, the electronic device 102 may copy the corresponding contact location into the first unoccupied position in the temporary vector (and overwrite the value in the current vector to indicate an empty position, for example).

The electronic device 102 may copy 412 the reordered 408 contact locations to the current vector from the temporary vector. When this is done, the current vector may include the contact locations in element positions that are consistent from the previous frame to the current frame. In this way, the contact locations become identified contact locations, since they are identified consistent with the order of previous contact locations (in a previous or last contact locations vector corresponding to the previous frame, for example).

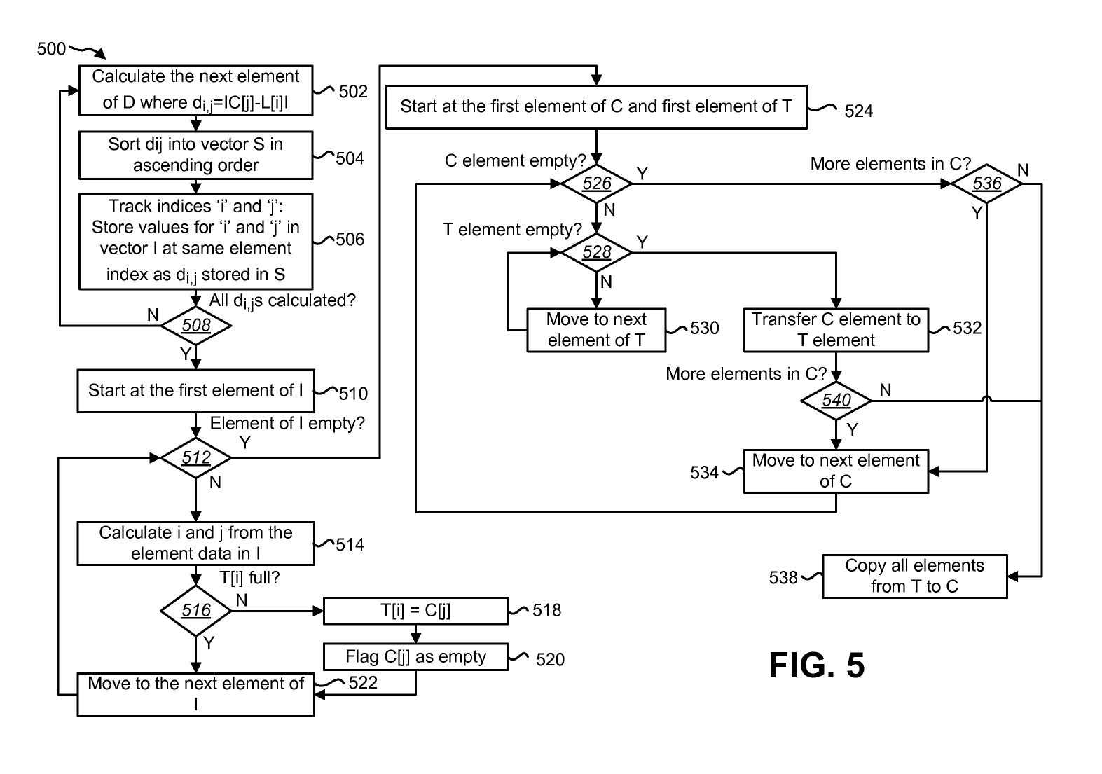

FIG. 5 is a flow diagram illustrating a specific example of one configuration of a method 500 for tracking multiple contacts. In FIG. 5, several definitions may be used as follows. ‘MAX’ refers to the maximum number of contact points that an electronic device 102 may have the ability to concurrently track. ‘N’ refers to the number of contact points in a current sensor image. ‘Frame N+1’ refers to the current sensor image. A previous sensor image is referred to as ‘Frame N’. ‘C’ denotes a set of contact locations from the current image. ‘L’ denotes a set of contact locations from a previous (last) image.

‘D’ denotes a “distance” matrix of d_{i,j} measurements. D is matrix with a maximum size of MAX×MAX (e.g., MAX²). Distance approximations (e.g., d_{i,j}) may occupy N columns of D, where N≦MAX. In one configuration, any column with and index>N will be filled with −1. It may also be possible for rows of arbitrary index to be filled with −1. These rows may represent a contact that was lifted sometime in the past, possibly earlier than the time represented by the last frame. ‘d_{i,j}’ denotes a pseudo-distance measurement (e.g., a distance approximation) between the ‘ith’ element of L and the ‘jth’ element of C, where d_{i,j}=|C[j]−L[i]|. ‘S’ denotes a “sorting” vector of maximum size (1×MAX²) containing the elements of D sorted in ascending order such that S[i−1]≦S[i]≦S[i+1]. ‘I’ is an “index” vector of length MAX² containing the indices of the contact pairs used to generate the elements of S. Thus, given S[k]=d_{i,j}, I[k] contains the values i and j.

‘T’ denotes a “temporary” vector used for reordering the elements of vector C. ‘x’ and ‘y’ denote x and y positions, respectively, (e.g., coordinates) of a most recently sensed contact. ‘last_x’ and ‘last_y’ denote the x and y positions, respectively, of a contact sensed previously or in the past. A value of −1 for an element denotes ‘unused’ or ‘empty’.

In one configuration, the electronic device 102 may track one or more contacts as follows. For all possible combinations (e.g., MAX×N total) of a contact location from L paired with a contact location from C, the electronic device 102 may calculate 502 a distance approximation of the distance between the locations as d_{i,j}=|x[j]−last_x[i]|+|y[j]−last_y[i]|, where |A| denotes the absolute value of A. In other words, the electronic device 102 may calculate 502 the next element d_{i,j} of the distance matrix D.

Since this definition of d_{i,j} is monotonically increasing, it may suffice in determining the minimum distance pairings. Several benefits may be realized by using this calculation for d_{i,j}. For example, fewer computation cycles are required compared to calculating the distance as sqrt(x²+y²). Furthermore, no floating point support is required for this calculation or computation.

One configuration of the distance matrix D (of dimensions (MAX, MAX), for example) may be illustrated as follows in Equation (1).

$$D = [ \begin{matrix}{d}_{0 , 0} & {d}_{0 , 1} & {d}_{0 , 2} & {d}_{0 , 3} & {d}_{0.4} & {d}_{0 , 5} & {d}_{0 , 6} & {d}_{0 , 7} & … & {d}_{0 , MA X} \\ {d}_{1 , 0} & {d}_{1 , 1} & {d}_{1 , 2} & {d}_{1 , 2} & {d}_{1 , 4} & {d}_{1 , 5} & {d}_{1 , 6} & {d}_{1 , 7} & & {d}_{1 , M A X} \\ & & & & ⋮ & & & & ⋱ & \\ {d}_{MAX , 0} & {d}_{MAX , 1} & {d}_{MAX , 2} & {d}_{MAX , 3} & {d}_{MAX , 4} & {d}_{MAX , 5} & {d}_{MAX , 6} & {d}_{MAX , 7} & & {d}_{MAX , MAX}\end{matrix} ] \qquad ( 1 )$$

One example of the distance matrix follows in Equation (2).

$$D = [ \begin{matrix}206 & 5 & 398 & - 1 & - 1 & - 1 & - 1 & - 1 & & - 1 \\ 6 & 205 & 198 & - 1 & - 1 & - 1 & - 1 & - 1 & & - 1 \\ - 1 & - 1 & - 1 & - 1 & - 1 & - 1 & - 1 & - 1 & … & - 1 \\ 194 & 405 & 2 & - 1 & - 1 & - 1 & - 1 & - 1 & & - 1 \\ - 1 & - 1 & - 1 & - 1 & - 1 & - 1 & - 1 & - 1 & & - 1 \\ & & & & ⋮ & & & & ⋱ & \\ - 1 & - 1 & - 1 & - 1 & - 1 & - 1 & - 1 & - 1 & & - 1\end{matrix} ] \qquad ( 2 )$$

In the example illustrated in Equation (2), d_{0,0}=206, d_{0,1}=5, d_{0,2}=398, d_{1,0}=6, d_{1,1}=205, d_{1,2}=198, d_{3,0}=194, d_{3,1}=405, d_{3,2}=2 and the remainder of the elements are −1, denoting empty or unused elements. In this example, N=3.

The electronic device 102 may sort 504 the distance approximations in ascending order into a sorting vector S. This may be accomplished by shifting the elements of S that have values larger than d_{i,j} and inserting d_{i,j} into the appropriate location. In one configuration, the sorting vector S may have the form illustrated in Equation (3).

S=[S₀S₁S₂S₃S₄−1−1 . . . −1](1×MAX²)

S₀≦S₁≦S₂≦S₃≦S₄≦ . . . (3)

Equation (3) denotes that the vector S has dimensions of (1×MAX²). Furthermore, Equation (3) illustrates that S is in ascending order, where each vector element (e.g., distance approximation) is less than or equal to the following vector element (e.g., distance approximation).

For example, assume that distance approximation d₃₀ conforms with the relationship d₁₀<d₃₀<d₁₂ and the vector S=[d₀₁ d₁₀ d₁₂ d₁₁ d₀₀ d₀₂ d₃₁ −1 −1 . . . −1] (1×MAX²). In this case, d₃₀ should be placed in a position between d₁₀ and d₁₂. In this example, the electronic device 102 shifts the elements of S from index 2 such that S=[d₀₁ d₁₀ d₁₂ d₁₂ d₁₁ d₀₀ d₀₂ d₃₁ −1 . . . −1] (1×MAX²). The electronic device 102 may then insert d₃₀ such that S=[d₀₁ d₁₀ d₃₀ d₁₂ d₁₁ d₀₀ d₀₂ d₃₁ −1 . . . −1] (1×MAX²). In another example, if d₁₂=d₃₀, (and d₃₀<d₁₁, for example) then values in the S vector may be shifted such that S=[d₀₁ d₁₀ d₁₂ d₁₁ d₁₁ d₀₀ d₀₂ d₃₁ −1 . . . −1] and d₃₀ is inserted such that S=[d₀₁ d₁₀ d₁₂ d₃₀ d₁₁ d₀₀ d₀₂ d₃₁ −1 . . . −1] (1×MAX²).

The electronic device 102 may track 506 the indices i and j associated with d_{i,j} based on the index vector I. This may be accomplished, for example, by storing values for i and j in the index vector I at the same element index as d_{i,j} stored in the sorting vector S. Continuing with the above example, an index vector I corresponding to the sorting vector may be I=[0x01 0x10 0x30 0x12 0x11 0x00 0x02 0x31 −1 −1 . . . −1]. In this example, the index vector I is expressed in hexadecimal in order to illustrate the indices i and j more clearly. For instance, the index value I[0]=0x01 indicates that i=0 and j=1. This matches the pairing that produced the distance approximation sorted into the sorting vector S[0], namely, d₀₁. More generally, the indices stored at I[a] were used to calculate or compute a distance (approximation, for example) stored at S[a]. It should be noted that elements of I may be expressed differently in some configurations.

The electronic device 102 may determine 508 whether all of the distance approximations d_{i,j} have been calculated. If not all of the distance approximations have been calculated, the electronic device 102 may return to calculate 502 the next element of D. If all of the distance approximations d_{i,j} have been calculated for the distance matrix D, the electronic device 102 may map and/or reorder the streams. For example, after all MAX×N calculations have been performed, the sorting vector S and index vector I may be used to reorder the streams. That is, the order of the elements of the current vector C may be rearranged to reflect a desired stream order.

In order to reorder the current vector C, a temporary vector T may be used. One or more of the elements of C may be mapped into the temporary vector T based on data in the index vector I. For example, each element of C may be copied to an element of T. Only the number of streams in the current sensor image (e.g., N) may be mapped. Furthermore, contacts that have lifted from the surface between the last and current frames may be present as elements in the last vector L that are not transferred into the temporary vector T. For example, assume that 3 streams are mapped. Assume that the index vector I=[0x32 0x01 0x10 0x30 0x12 0x11 0x00 0x02 0x31 −1 −1 . . . −1]. In this example, the 0^{th} element of the index vector I[0]=0x32 indicates that a contact #3 is found in the current vector C at C[2] (e.g., index 2). Furthermore, I[1] indicates that a contact #0 is found at C[1] and I[2] indicates that a contact #1 is found at C[0].

The electronic device 102 may empty all the elements of the temporary vector T. In the configuration illustrated in FIG. 5, the electronic device 102 starts 510 at the first element of the index vector I. For example, the electronic device 102 starts 510 by accessing the first element (at index 0, for example) of the index vector I. The electronic device 102 may determine 512 whether the current element of the index vector I is empty. In one configuration, for example, the electronic device 102 determines whether the element at the current index in vector I is −1, denoting an empty or unused element.

If the electronic device 102 determines 512 that the current element or the element at the current index is not empty (e.g., the element is an index value) in the index vector I, the electronic device 102 may calculate or determine 514 the indices i and j from the element data in the index vector I. In other words, the electronic device 102 may determine the index numbers from the element at the current index of index vector I. For example, an element value of 0x12 denotes the index numbers of i=1 and j=2.

The electronic device 102 may determine 516 whether the element at index i in the temporary vector T is full. If T[i] is full (e.g., not −1), the corresponding contact may have already been identified. If T[i] is full, the electronic device may move 522 to the next element of the index vector I. In other words, the electronic device 102 may ignore the match by returning to determine 512 whether the (next) element of I is empty or calculate 514 i and j from the element data in I. If the element from the temporary vector T[i] is not full or “empty” (e.g., −1), the electronic device 102 may copy 518 the contact location at index j from the current vector C to the temporary vector T such that T[i]=C[j]. The electronic device 102 may flag (or overwrite) 520 C[j] as empty. For example, the electronic device may clear the element in the current vector at index j (e.g., C[j]) by overwriting the element with −1. This may indicate that stream j has been reordered. The electronic device 102 may move 522 to the next element of I. Thus, operation may continue through all valid (e.g., not −1) elements of I.

If the electronic device 102 determines 512 that the (next) element of the index vector I is empty, the electronic device 102 may assign an index to new contact streams. For example, new streams may have elements remaining in the current vector C. In general, the electronic device 102 may scan through all the elements of the current vector C to find any value data (e.g., not −1). If and when data is found, the electronic device 102 may scan up through the temporary vector T searching for the next empty element. The electronic device 102 may load the temporary vector T with the unassigned data from the current vector C and clear the element of C (e.g., write a −1 to that element).

More specifically, the electronic device 102 may start 524 at the first (e.g., 0^{th}) element of the current vector C and the first (e.g., 0^{th}) element of the temporary vector T. The electronic device 102 may determine 526 whether the element in C is empty. If the electronic device 102 determines 526 that the element in C is empty, then the electronic device 102 may determine 536 whether there is/are more elements in C (e.g., the last index in C has not been reached or another contact location is in C). If the electronic device 102 determines 536 that there are not one or more elements in C (e.g., the last index has been reached or a predetermined number of current contact points has been transferred to T), then the electronic device 102 may copy 538 all of the elements from the temporary vector T to the current vector C (e.g., copy all MAX elements from T to C). If the electronic device 102 determines 536 that there are more elements in C, then the electronic device 102 may move 534 to the next element of C and return to determining 526 whether the element in C is empty.

If the element in C is not empty (e.g., it is or has a contact location), then the electronic device 102 may determine 528 whether the element in T is empty. If the element in T is not empty, then the electronic device 102 may move 530 to the next element of T and return to determining 528 whether the element in T is empty. If the element in T is empty, then the electronic device 102 may transfer 532 the C element to the T element. The electronic device 102 may determine 540 whether there are one or more elements (e.g., contact locations or indices) in C. If the electronic device 102 determines 540 that there are not any more elements in C, then the electronic device 102 may copy 538 all of the elements from T to C. However, if the electronic device 102 determines 540 that there is another element in C, operation may move 534 to the next element of C. The electronic device 102 may return to determining 526 whether the element in C is empty. Once the electronic device 102 determines 526 that the element in C is empty, determines 536 that there are no more elements in C and copies 538 all of the elements from T to C, the current vector C may contain contact (location) data in element locations that are consistent from past (e.g., a previous frame) to present (e.g. the current frame).

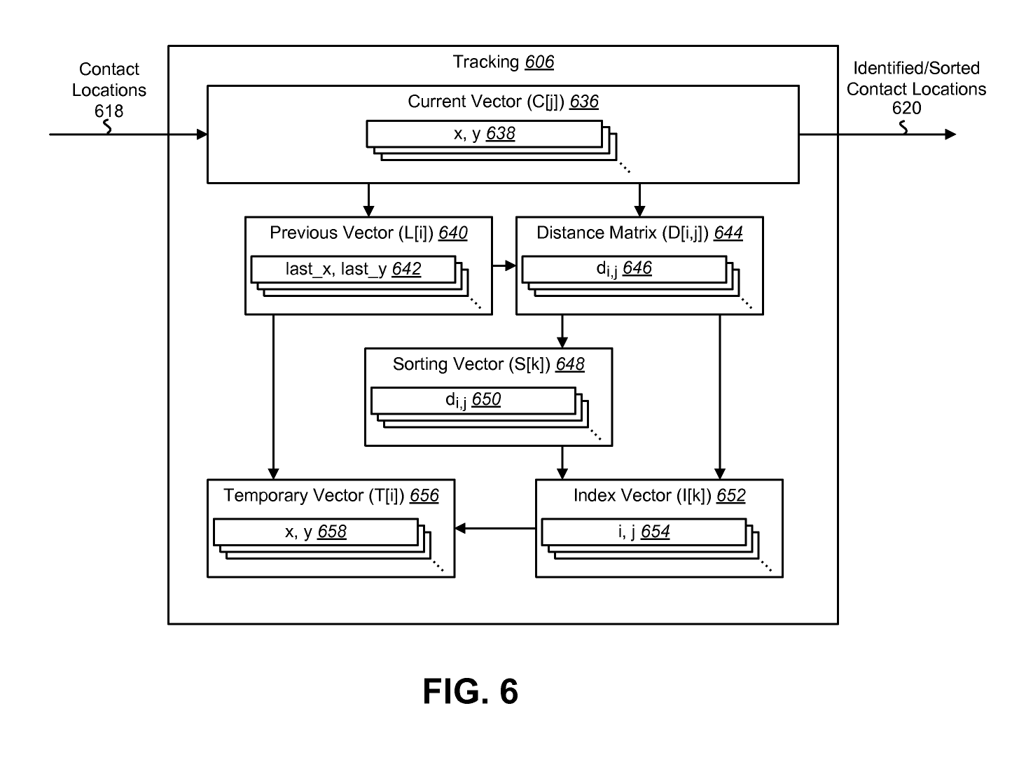

FIG. 6 is a block diagram illustrating one configuration of a tracking module 606. The tracking module 606 may include a current vector (C[j]) 636, a previous (or last) vector (L[i]) 640, a distance matrix (D[i, j]) 644, a sorting vector (S[k]) 648, an index vector (I[k]) 652 and/or a temporary vector (T[i]) 656. The tracking module 606 may receive contact locations 618 from a sensor 104 and produce identified or sorted contact locations 620. In other words, the tracking module 606 may produce contact location identities 620.

The current vector (C[j]) 636 includes x and y coordinates 638. The x and y coordinates 638 may be the contact locations 618 received from a sensor 104. The previous vector (L[i]) 640 includes coordinates last_x and last_y 642 corresponding to contact locations from a previous frame (e.g., from the last frame or most recent frame before the current frame). The distance matrix (D[i, j]) 644 may include distance approximations d_{i,j} 646 that are calculated or computed based on the current vector 636 and the previous vector 640. The sorting vector (S[k]) 648 may include distance approximations d_{i,j} 650 from the distance matrix (D[i, j]) 644 that are sorted in a particular order. For example, the distance approximations d_{i,j} 650 may be sorted in ascending order.

The index vector (I[k]) 652 may include indices i and j 654 that may be determined based on the distance matrix (D[i, j]) 644 and the sorting vector (S[k]) 648. For example, the index vector (I[k]) 652 may include indices i and j 654 from the distance matrix (D[i, j]) 644 corresponding to and in the same order as the distance approximations d_{i,j} 650 in the sorting vector (S[k]) 648.

The temporary vector (T[i]) 656 may include x and y coordinates or contact locations 658 from the current vector (C[j]) 636 based on the indices i and j 654 from the index vector (I[k]) 652. The x and y coordinates 638 from the current vector (C[j]) 636 may be mapped and/or transferred into the temporary vector (T[i]) based on the indices i and j 654 from the index vector (I[k]) 652. More specifically, the index i from the index vector (I[k]) 652 may indicate the contact number. For example, assuming that there are 3 contacts, one contact may be contact #0, another may be contact #1 and another may be contact #2. The index j from the index vector (I) 652 may indicate the index number where the coordinates x and y 638 corresponding to the contact number i may be located in current vector C (C[j]) 636.

The contacts may be beneficially placed in order of contact number. For example, the electronic device 102 (e.g., tracking module 606) may copy the contact location or coordinates 638 from index j in the current vector C[j] to index in the temporary vector T[i] 656. In this way, the x and y coordinates 638 in the current vector C[j] 636 may be mapped into the temporary vector T[i] 656 such that the contact number of the x and y coordinates 658 corresponds to the index number i in the temporary vector T[i] 656. Thus, for example, contact #0 will be placed at index i=0, contact #1 will be placed at index i=1 and contact #2 will be placed at index i=2, etc. Once the x and y coordinates 658 are mapped to the temporary vector T[i] 656 and any new contact streams (e.g., contact locations) are added to the temporary vector T[i] 656, the entire contents of the temporary vector T[i] 656 may be copied into the current vector C[j] 636 (in the same order, for example).

At this point, the current vector C[j] 636 includes identified or sorted contact locations 620, which may be provided to the electronic device 102 (e.g., to the OS 208, hardware 210 and/or software 212). This procedure may repeat. For example, when the tracking module 606 receives another set of contact locations 618, the contents of the current vector C[j] 636 may be copied into the previous vector L[i] 640 and the x and y coordinates 638 in the current vector C[j] may be overwritten with the (new) contact locations 618. The above calculation and sorting procedure may then repeat, such that the x and y coordinates 638 may be ordered consistently (according to contact number) from the previous vector L[i] 640 to the current vector 636.

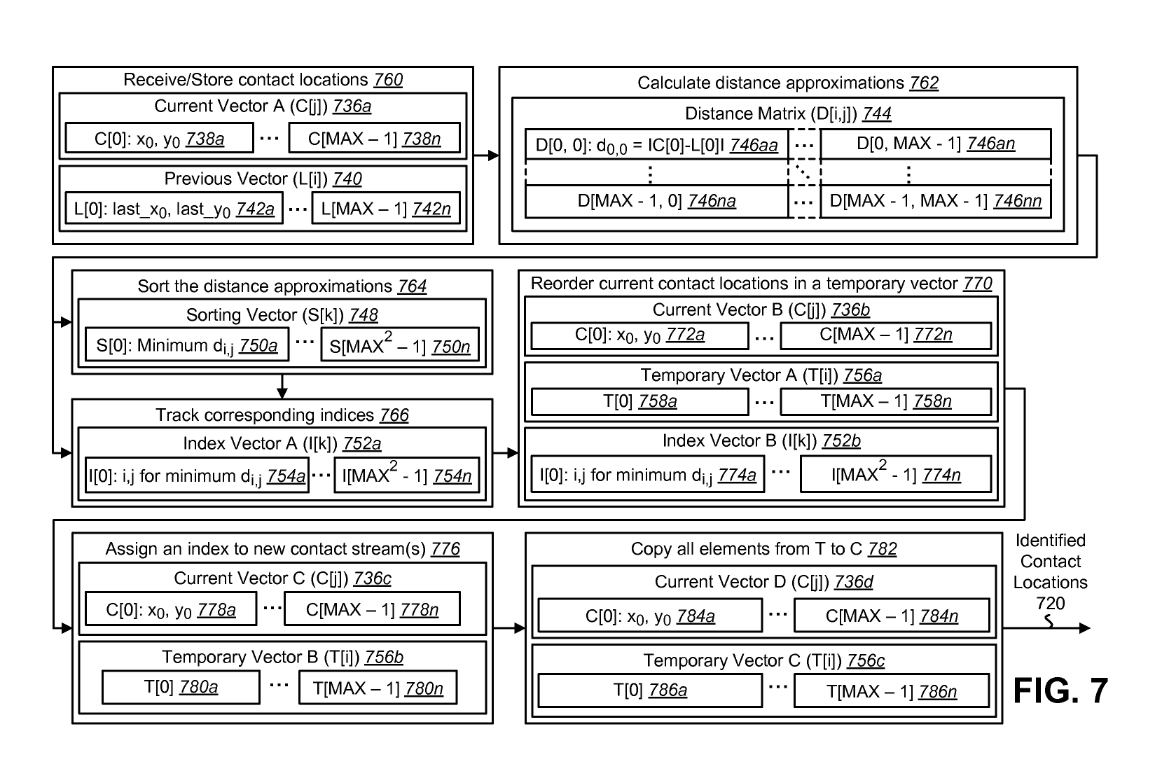

FIG. 7 is a diagram illustrating one example of functional detail of systems and methods for tracking multiple contacts. An electronic device 102 may receive and/or store 760 contact locations. These contact locations may be received and/or stored as x and y coordinate pairs. For example, a previous or last vector (L[i]) 740 may include coordinate pairs as one or more vector elements 742a-n for a set of contacts from a previous or last time frame. For example, the sets of coordinate pairs last_xᵢ, last_yᵢ 742 may range from last_x₀, last_y₀ 742a to last_x_{N-1}, last_y_{N-1}, where i (i.e., the subscript) denotes an index number. The number N denotes a number of previous contacts (where N≦MAX, for example). The previous vector L([i]) may have dimensions (1×MAX) and may range from L[0] 742a to L[MAX−1] 742n, where the unused elements are denoted with a −1. It should be noted that the number of previous contacts N may be the same as or different from the number of current contacts N in some instances. In other words, the number of meaningful elements in C and L may the same or different.

A current vector A (C[j]) 736a may initially receive and include one or more unsorted sets of coordinate pairs xⱼ, yⱼ as vector elements 738a-n ranging from x₀, y₀ 738a to x_{N-1}, y_{N-1} 738, where j (i.e., the subscript) denotes an index number. The number N denotes the current number of contacts (where N≦MAX, for example). Current vector A (C[j]) 736a may include the same or a different number of contacts (e.g., more or fewer) than the previous vector (L[i]) 740. The current vector C([j]) 736 may have dimensions (1×MAX) and may range from C[0] 738a to C[MAX−1] 738n, where the unused elements are denoted with a −1.

The electronic device 102 may calculate 762 distance approximations using current vector A (C[j]) 736a and the previous vector (L[i]) 740. More specifically, the electronic device 102 may calculate or determine a distance matrix (D[i, j]) 744 based on current vector A (C[j]) 736a and previous vector (L[i]) 740. For example, each of the distance approximation elements d_{i,j} of the distance matrix (D[i, j]) 744 may be calculated according to the equation d_{i,j}=|C[j]−L[i]| or d_{i,j}=|x[j]−last_x[i]|+|y[j]−last_y[i]|. More specifically, the distance approximations d_{i,j} of the distance matrix (D[i, j]) 744 may range from d_{0,0} at D[0, 0] 746aa (calculated as |C[0]−L[0]|, for example) to d_{MAX-1,MAX-1} 746nn (if a maximum number of previous and current contacts are used, for example). In one configuration, the distance matrix (D[i, j]) 744 is a matrix of size (MAX, MAX) with unused elements containing a −1. The number MAX may denote the maximum number of contact points that the electronic device 102 may track. Thus, the elements in the distance matrix (D[i, j]) 744 may range from D[0, 0] 746aa to D[MAX−1, MAX−1] 746nn. For example, the number of current contacts N≦MAX, with the remaining unused elements 746 being denoted as −1. For example, assuming that current vector A (C[j]) 736a includes 2 contact locations and the previous vector (L[i]) 740 include 3 contact locations, then the distance matrix (D[i, j]) 744 may include 6 distance approximation d_{i,j} elements 746, with the remainder of the elements 746 being set to −1 to denote an unused or empty element.

The electronic device 102 may sort 764 the distance approximations. For example, the electronic device 102 may sort 764 the distance approximations in ascending order. Accordingly, the electronic device 102 may use a sorting vector (S[k]) 748. The electronic device 102 may copy or transfer the distance approximations 746 from the distance matrix (D[i, j]) 744 into the sorting vector (S[k]) 748 from the minimum distance approximation d_{i,j} 750a to the maximum distance approximation d_{i,j} 750. The sorting vector S[k] 748 may have dimensions 1×MAX². Thus, any unused elements (up to the element S[MAX²−1] 750n, for example) of the sorting vector S[k] 748 may be set to −1 to denote an unused or empty element.

The electronic device 102 may track 766 corresponding indices. More specifically, the electronic device 102 may track 766 indices corresponding to the sorted distance approximations 750 in the sorting vector S[k] 748. For example, the electronic device 102 may place or store the indices i and j (of the distance approximations d_{i,j} 746 that are arranged in the distance matrix (D[i, j]) 744) in index vector A (I[k]) 752a according to the order of the distance approximations 750a-n in the sorting vector S[k] 748. In other words, index vector A (I[k]) 752a may include elements ranging from indices i and j for a minimum d_{i,j} 754a to indices i and j for a maximum d_{i,j} 754. Index vector A (I[k]) 752a may be of size (1×MAX²). Thus, any unused elements of index vector A (I[k]) 752a may be set to −1 to denote an empty or unused element (up to the element I[MAX²−1] 754n, for example).

The electronic device 102 may reorder 770 current contact locations in a temporary vector. For example, the electronic device 102 may use index vector B (I[k]) 752b to map or reorder the contact locations (e.g., x and y coordinates) xⱼ, yⱼ 772 (ranging from x₀, y₀ 772a to x_{N-1}, y_{N-1} 772 and possibly up to C[MAX−1] 772n, for example) of current vector B (C[j]) 736b into temporary vector A (T[i]) 756a. For each set of i and j indices in index vector B (I[k]) 752b (from inidices i and j for the minimum d_{i,j} 774a to indices i and j for a maximum d_{i,j}, and possibly up to I[MAX−1] 774n, for example), the electronic device 102 may copy or transfer the contact location 772 at index j in current vector B (C[j]) 736b to index i in temporary vector A (T[i]) 756a, unless a contact location is already occupying temporary vector A (T[i]) 756a at index i. If a contact location is already occupying temporary vector A (T[i]) 756a at index i, operation may move to the next set of i and j indices in index vector B (I[k]) 752b. Temporary vector A (T[i]) 756a may have dimensions 1×MAX for elements T[0] to T[MAX−1] 758n. Thus, temporary element T[0] 758a and possibly up to temporary element T[MAX−1] 758n may include reordered contact locations 772 from current vector B (C[j]) 736b according to a mapping determined based on index vector B (I[k]) 752b. However, if fewer than the maximum number of contacts are mapped, the remaining elements of temporary vector A (T[i]) 756a may be set to −1 to indicate an unused or empty element. It should be noted that when a contact location 772a-n in current vector B (C[j]) 736b is copied or transferred into temporary vector A (T[i]) 756a, the element in current vector B (C[j]) 736b may be overwritten with a −1 to indicate that it has been transferred or copied.

The electronic device 102 may assign 776 an index to any new contact stream(s). For example, the number of contacts in a previous vector (L[i]) 740 may be fewer than the number of contacts in the current vector 736. In such a case, there may be one or more additional contact locations 778 in current vector C 736c (that were not initially mapped to temporary vector B 756b, for example). The electronic device 102 may accordingly scan through the elements (e.g., C[0] 778a to C[MAX−1] 778n) in current vector C (C[j]) 736c to find value data (e.g., not −1). For each element of value data (e.g., each contact location) that is found, the electronic device 102 may transfer or copy that contact location to the next empty element in temporary vector B (T[i]) (in the range of T[0] 780a to T[MAX−1] 780n, for example).

The electronic device 102 may copy 782 all of the elements in temporary vector C (T[i]) 756c (e.g., from T[0] 786a to T[MAX−1] 786n) to current vector D (C[j]) 736d. Thus, current vector D (C[j]) 736d may include sorted contact locations or coordinate sets from x₀, y₀ 784a to x_{N-1}, y_{N-1} 784 (possibly up to C[MAX−1] 784n), for example. The electronic device 102 may then use the sorted or identified contact locations 720 to perform various operations and/or trigger events, etc.

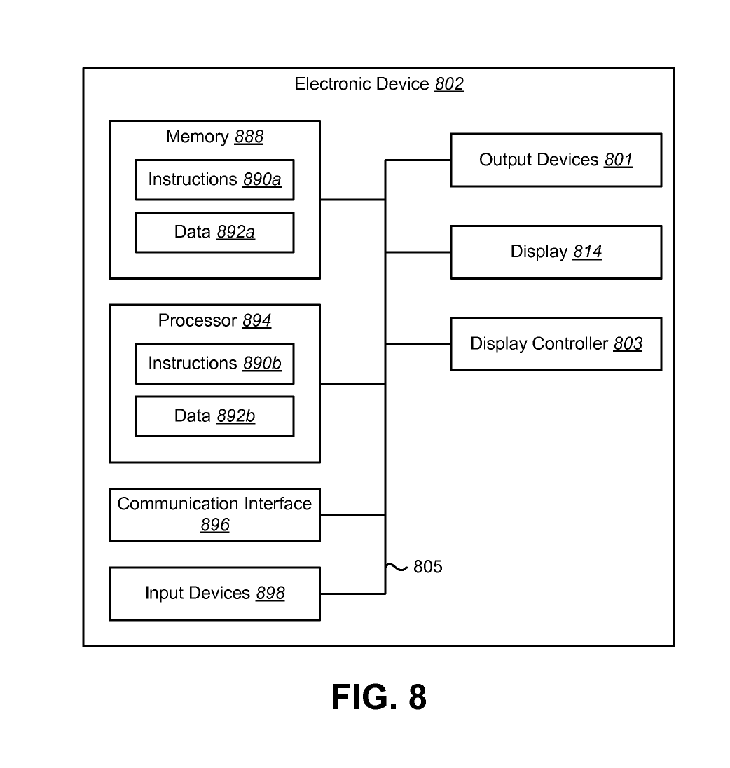

FIG. 8 illustrates various components that may be utilized in an electronic device 802. The electronic device 802 may be utilized as the electronic devices 102, 202 illustrated previously. The electronic device 802 includes a processor 894 that controls operation of the electronic device 802. The processor 894 may also be referred to as a CPU. Memory 888, which may include both read-only memory (ROM), random access memory (RAM) or any type of device that may store information, provides instructions 890a and data 892a to the processor 894. A portion of the memory 888 may also include non-volatile random access memory (NVRAM). Instructions 890b and data 892b may also reside in the processor 894. Instructions 890b and/or data 892b loaded into the processor 894 may also include instructions 890a and/or data 892a from memory 888 that were loaded for execution or processing by the processor 894. The instructions 890b may be executed by the processor 894 to implement the systems and methods disclosed herein.

The electronic device 802 may include one or more communication interfaces 896 for communicating with other electronic devices. The communication interfaces 896 may be based on wired communication technology, wireless communication technology, or both. Examples of communication interfaces 896 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The electronic device 802 may include one or more output devices 801 and one or more input devices 898. Examples of output devices 801 include a speaker, printer, etc. One type of output device that may be included in an electronic device 802 is a display device 814. Display devices 814 used with configurations disclosed herein may utilize any suitable image projection technology, such as a cathode ray tube (CRT), liquid crystal display (LCD), light-emitting diode (LED), gas plasma, electroluminescence, or the like. A display controller 803 may be provided for converting data stored in the memory 888 into text, graphics, and/or moving images (as appropriate) shown on the display 814. Examples of input devices 898 include a keyboard, mouse, microphone, remote control device, button, joystick, trackball, touchpad, touchscreen, lightpen, etc.

The various components of the electronic device 802 are coupled together by a bus system 805, which may include a power bus, a control signal bus and a status signal bus, in addition to a data bus. However, for the sake of clarity, the various buses are illustrated in FIG. 8 as the bus system 805. The electronic device 802 illustrated in FIG. 8 is a functional block diagram rather than a listing of specific components.

The term “computer-readable medium” or “processor-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Each of the methods disclosed herein comprises one or more steps or actions for achieving the described method. The method steps and/or actions may be interchanged with one another, combined into a single step or incorporated into other ancillary aspects of the communication system without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. An electronic device configured for tracking multiple contacts, comprising:
a processor;
memory in electronic communication with the processor;
instructions stored in the memory, the instructions being executable to:
receive a plurality of current contact locations for a plurality of contacts;
track the plurality of contacts, comprising:
calculating distance approximations between the plurality of current contact locations and at least one previous contact location;
sorting the distance approximations to identify the current contact points; and
perform an operation based on tracking the plurality of contacts.

2. The electronic device of claim 1, wherein tracking the plurality of contacts further comprises tracking indices corresponding to the distance approximations.

3. The electronic device of claim 1, wherein tracking the plurality of contacts further comprises determining a mapping.

4. The electronic device of claim 1, wherein tracking the plurality of contacts further comprises reordering the current contact locations in a temporary vector.

5. The electronic device of claim 4, wherein tracking the plurality of contacts further comprises copying the reordered contact locations to a current vector from the temporary vector.

6. The electronic device of claim 1, wherein tracking the plurality of contacts further comprises assigning an index to a new contact.

7. The electronic device of claim 1, wherein the distance approximations are calculated according to an equation d_{i,j}=|C[j]−L[i]|, wherein d_{i,j} is a distance approximation, i is an index for a contact location in a previous vector L and j is an index for a contact location in a current vector C.

8. The electronic device of claim 1, wherein the distance approximations are calculated according to an equation d_{i,j}=|x[j]−last_x[i]|+|y[j]−last_y[i]|, wherein d_{i,j} is a distance approximation, i is an index for a contact location in a previous vector, j is an index for a contact location in a current vector, x is an x coordinate in the current vector, y is a y coordinate in the current vector, last_x is an x coordinate in a previous vector and last_y is a y coordinate in a previous vector.

9. The electronic device of claim 1, wherein the distance approximations are arranged in a distance matrix, wherein d_{i,j} is a distance approximation at indices i and j.

10. The electronic device of claim 1, wherein the distance approximations are sorted in ascending order.

11. The electronic device of claim 1, wherein performing an operation comprises producing an output using a device included in the electronic device.

12. The electronic device of claim 1, wherein performing an operation comprises producing an output using a display.

13. The electronic device of claim 1, wherein the plurality of current contact locations is received from a touch screen.

14. A method for tracking multiple contacts, comprising:
receiving a plurality of current contact locations for a plurality of contacts;
tracking the plurality of contacts on an electronic device, comprising:
calculating distance approximations between the plurality of current contact locations and at least one previous contact location;
sorting the distance approximations to identify the current contact points; and
performing an operation based on tracking the plurality of contacts.

15. The method of claim 14, wherein tracking the plurality of contacts further comprises tracking indices corresponding to the distance approximations.

16. The method of claim 14, wherein tracking the plurality of contacts further comprises determining a mapping.

17. The method of claim 14, wherein tracking the plurality of contacts further comprises reordering the current contact locations in a temporary vector.

18. The method of claim 17, wherein tracking the plurality of contacts further comprises copying the reordered contact locations to a current vector from the temporary vector.

19. The method of claim 14, wherein tracking the plurality of contacts further comprises assigning an index to a new contact.

20. The method of claim 14, wherein the distance approximations are calculated according to an equation d_{i,j}=|C[j]−L[i]|, wherein d_{i,j} is a distance approximation, i is an index for a contact location in a previous vector L and j is an index for a contact location in a current vector C.

21. The method of claim 14, wherein the distance approximations are calculated according to an equation d_{i,j}=|x[j]−last_x[i]|+|y[j]−last_y[i]|, wherein d_{i,j} is a distance approximation, i is an index for a contact location in a previous vector, j is an index for a contact location in a current vector, x is an x coordinate in the current vector, y is a y coordinate in the current vector, last_x is an x coordinate in a previous vector and last_y is a y coordinate in a previous vector.

22. The method of claim 14, wherein the distance approximations are arranged in a distance matrix, wherein d_{i,j} is a distance approximation at indices i and j.

23. The method of claim 14, wherein the distance approximations are sorted in ascending order.

24. The method of claim 14, wherein performing an operation comprises producing an output using a device included in the electronic device.

25. The method of claim 14, wherein performing an operation comprises producing an output using a display.

26. The method of claim 14, wherein the plurality of current contact locations is received from a touch screen.

27. A non-transitory tangible computer-readable medium for tracking multiple contacts comprising executable instructions for:
receiving a plurality of current contact locations for a plurality of contacts;
tracking the plurality of contacts on an electronic device, comprising:
calculating distance approximations between the plurality of current contact locations and at least one previous contact location;
sorting the distance approximations to identify the current contact points; and
performing an operation based on tracking the plurality of contacts.
